(19) United States
(12) Patent Application Publication
(10) Pub. No.: US 2005/0217994 A1
(43) Pub. Date: Oct. 6, 2005

(54) Use of a reversed-phase support material in capillary electrochromatography

(75) Inventors: Klaus Unger, Seeheim (DE); Karl-Siegfried Boos, Gauting (DE); Angelika Muscate-Magnussen, Hamburg (DE); Dieter Lubda, Darmstadt (DE)

Correspondence Address: JACOBSON HOLMAN PLLC, 400 SEVENTH STREET N.W., SUITE 600, WASHINGTON, DC, 20004, US

(73) Assignee: Evotec BioSystems AG & Merch Patent GmbH

(21) Appl. No.: 11/134,282

(22) Filed: May 23, 2005

Related U.S. Application Data
(63) Continuation of application No. 09/914,027, filed on Jan. 8, 2002.

(30) Foreign Application Priority Data
Feb. 22, 1999 (DE) 199 07 296.5

(51) Int. Cl. G01N 27/453

(52) U.S. Cl. 204/455; 204/605

(57) ABSTRACT

The use of a support material for capillary electrochromatography is disclosed, wherein the support material, which is based on a base material containing hydroxy groups, has reversed phases which are limited to the inner surfaces of porous particles, said reversed phases consisting of fatty acid residues. Further, separating capillaries suitable for such a use are disclosed.

The present invention relates to the use of a reversed-phase support material in capillary electrochromatography (CEC).

In general, analytical methods are at best selective; however, only a few, if any, are really specific. Consequently, when an analysis is performed, separation of the analyte from interfering accompanying substances is inevitable.

In chromatographic separations, the sample is dissolved in a mobile phase which may be, for example, a gas, a liquid or a supercritical fluid. The mobile phase is moved through a stationary phase which is not miscible with it and is accommodated in a column, for example, or fixed at a solid surface. The two phases are selected in such a way that the sample components become distributed between the mobile and stationary phases in different ratios. The components which are strongly retained by the stationary phase travel on slowly with the mobile phase. In contrast, the components which are weakly retained by the stationary phase travel fast. Due to these differences, the sample components will separate into discrete bands.

A chromatographic concept which combines the advantages of capillary liquid chromatography (e.g., HPLC) and capillary electrophoresis (CE) is the so-called capillary electrochromatography (CEC). Essentially, CEC can be considered a hybrid of HPLC and CE (Colon et al., Analytical Chemistry News & Features 1995; Aug. 1, 461A-467A). As in HPLC, the components of a sample are separated due to a different distribution between stationary and mobile phases. In addition however, as in CE, an electro-osmotic flow is produced by applying a voltage. The separations can be performed isocratically or with a gradient. The columns are preferably filled with silica gel particles, typically having particle diameters in a range of from 1 to 5 μm.

An advantage of this method is the possibility of separating anionic, cationic and neutral molecules. However, a great problem lies in the analysis of complex samples, especially biological ones. The latter, such as hemolyzed blood, plasma, serum, milk, saliva, fermenter broth, urine, supernatants of cell culture, food and tissue homogenizates or extracts from natural products, contain a high proportion of matrix components, such as proteins and salts, in addition to the analyte.

Proteins and other macromolecules are precipitated, for example, by high proportions of organic solvents in the mobile phase, or non-specifically and irreversibly bound by residual silanol groups at the surface of a chromatographic support, or denatured. When a porous stationary phase is used, they block the access to the pores and thus reduce the number of chromatographic adsorption centers. Due to the reduced exchange of materials between the stationary and mobile phases connected therewith, these processes result in a loss of capacity and selectivity of the column. In addition, non-specific adsorption results in variations of the electro-osmotic flow and in non-reproducible retention times of the analytes. In all cases, the CEC column is highly damaged or rendered useless. Therefore, it is necessary to remove these matrix components from the sample prior to the CEC analysis.

These problems are all the more important since they pertain to determinations which are performed in a high number: for example, therapy control, determination of endogenous substances, or the high-throughput screening for potential pharmacologically active substances, especially using extracts from natural products.

Common sample processing methods include, for example, cartridge methods or the use of precolumns, preferably filled with silica gel particles, the elution of the analyte preferably being effected by liquid desorption (HPLC). However, the necessary sample processing steps are often time-, cost- and labor-intensive, and due to the necessary transfer of the analyte to a separating column, result in a volume enlargement of the sample, which results in a loss of selectivity and sensitivity of the separating method.

Boos et al. (LC.GC 1997, 15, 602-611; LC.GC 1996, 14, 554-560) describe a support material based on alkyldiol-silica (ADS) which ensures the quantitative separation of proteins and other macromolecular components. It is characterized by a surface which is inert towards biomolecules, and its pores are occupied by alkyl groups. Its pore size enables small target molecules (analytes) to access while the large matrix molecules remain excluded. This material was especially developed for HPLC analyses.

The methods of capillary electrochromatography and HPLC are considerably distinct, in particular, by the electro-osmotic forces occurring in CEC. Thus, materials and conditions suitable for HPLC cannot be simply transferred to the method of CEC (Colon et al., 1997, Analytical Chemistry & Features, August 1).

Therefore, it was all the more surprising that the use of a support material for capillary electrochromatography (CEC), which is based on a base material containing hydroxy groups and has reversed phases limited to the inner surfaces of porous particles, said reversed phases consisting of fatty acid residues, in capillary electrochromatography enables an essentially quantitative separation of the analyte from other sample components, especially proteins and other macromolecular components (sample matrix) of the sample.

Thus, the invention relates to the use of a support material for capillary electrochromatography, wherein the support material, which is based on a base material containing hydroxy groups, has reversed phases which are limited to the inner surfaces of porous particles, said reversed phases consisting of fatty acid residues.

In addition, the invention relates to a capillary for capillary electrochromatography filled with a support material, wherein the support material in the capillary, which is based on a base material containing hydroxy groups, has reversed phases which are limited to the inner surfaces of porous particles, said reversed phases consisting of fatty acid residues.

The use of the support material in CEC according to the invention permits to separate the analyte from other components of the sample without diluting it. In the use of the support material according to the invention, the reproducibility with respect to plate numbers, retention time and resolution of the column is retained even after the repeated injection of complex samples, especially samples containing serum and cell culture media.

In another embodiment, the use of the support material according to the invention even permits the combined sample processing and separation of complex samples on a single CEC column. With respect to the separating performance, sensitivity, signal-to-noise ratio, selectivity, service life of the column and costs, it is equivalent or even superior to sample processing and separation performed on separated columns. This for the first time enables the use of such a system in a high-throughput process, such as the high-throughput screening for potential pharmacologically active substances.

Thus, the use of the support material according to the invention is altogether characterized by the following properties:
there is a possibility of repeated direct injection of untreated samples, especially biological samples, on one CEC column;
the protein matrix is quantitatively removed;
the analyte can be concentrated at the upper brim of the column and quantitatively separated off and into its components independently of the matrix;
high separating performance, sensitivity, accuracy, very good signal-to-noise ratio;
high extent of reproducibility with respect to plate numbers, retention time and resolution of separation in the column;
automatic operation is possible;
high number of analytical runs, continuous operation of the column;
low costs per analysis.

The use according to the invention is advantageous in a CEC method for sample processing, wherein the sample consisting of an analyte and other sample components
is applied to a CEC column system;
an electro-osmotic flow is produced by applying a voltage, whereby the sample molecules are moved and/or the sample molecules migrate according to their charge-to-mass ratio;
the sample matrix is eluted by applying a wash buffer;
the analyte is eluted by applying a transfer buffer.

Particularly preferred is the use according to the invention in a CEC method for the combined sample processing and separation, wherein the sample consisting of an analyte and other sample components
is applied to a CEC column system;
an electro-osmotic flow is produced by applying a voltage, whereby the sample molecules are moved and/or the sample molecules migrate according to their charge-to-mass ratio;
the sample matrix is eluted by applying a wash buffer;
the analyte is separated and eluted by applying an elution buffer.

The method according to the invention not only allows the sample matrix to be separated, but also the analyte to be concentrated; experimental details are disclosed in Example 6. Using this variant of the present invention, a concentration of the analyte by a factor of between 10 and 1000 is achieved.

In a preferred embodiment, for the precise characterization of the composition of the analyte, both qualitatively and quantitatively, it is possible to perform various spectrometric and spectroscopic analytical methods subsequent to the separation and/or elution. Thus, for example, UV detection is employed in Example 1.

However, it may also be preferred to supply the analyte fractions to another column system for further separation subsequent to the separation.

CEC devices suitable for the use according to the invention are known to the skilled person; the same applies to peripheral devices, such as voltage supply devices, temperature-control means, detection devices, separating capillaries.

Separating capillaries used for CEC typically have inner diameters of between 20 and 300 μm, the lower value being limited by handling requirements, and the upper value being limited by the possibility to dissipate the Joule heat produced by the flow of current. The length of such capillaries is usually from a few centimeters to about 50 cm, the upper value being again limited by handling requirements, and also by the resulting analysis time since the linear flow is limited in capillary electrochromatography. The particular support materials usually employed for filling the separating capillaries typically have outer diameters of less than 20 μm, especially from 1 to 5 μm. The sorbent bed is usually bounded by frits on both sides, wherein the frits can also be produced by sintering sorbent particles.

The separating materials used according to the invention which have reversed phases limited to the inner surfaces of porous particles, the reversed phases consisting of fatty acid residues, have mesopores whose width is typically within a range of from 2 to 50 nm, as is common for the separation of low-molecular analytes. Depending on the desired degree of lipophilicity, the fatty acid residues have from 2 to 24 carbon atoms. As the base supports, materials containing hydroxy groups, such as silica gel, porous glass or organic polymers, are suitable. The preparation of such separating materials is disclosed in DE 41 30 475 and EP 0 537 461.

Further embodiments of the device are explained below with reference to the enclosed Figures.

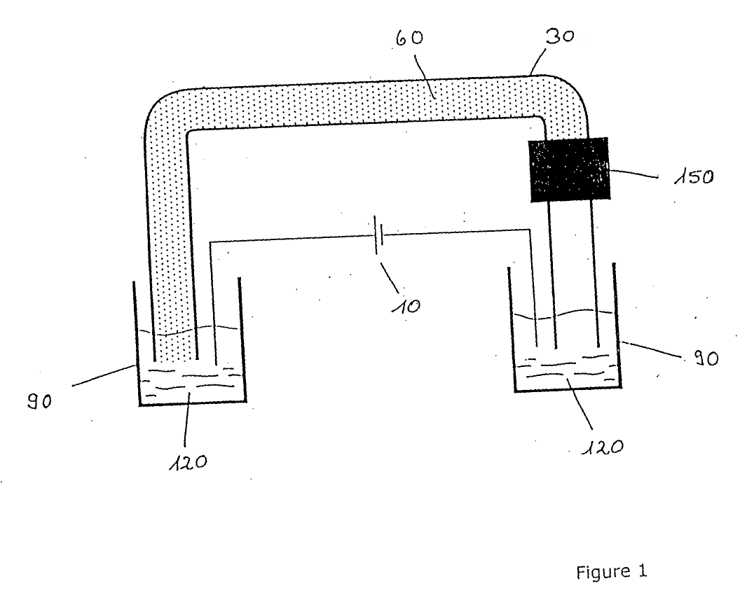

FIG. 1 shows a CEC column system which consists of a single column for the sample processing and/or separation.

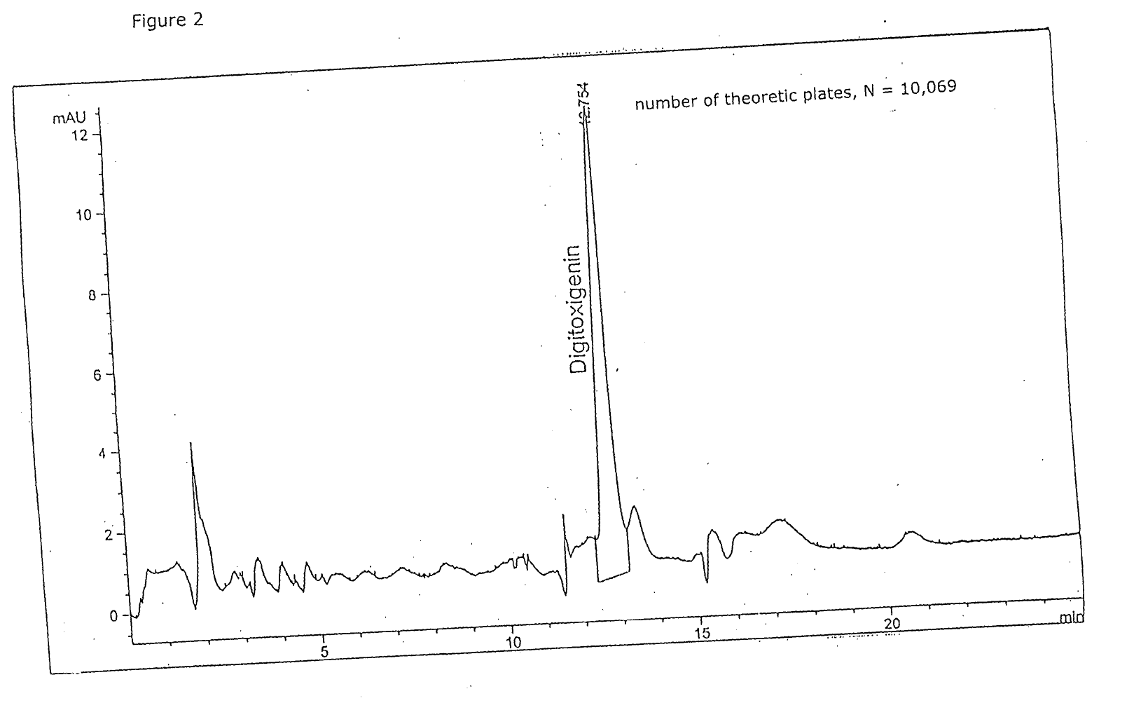

FIG. 2 shows the electropherogram of digitoxigenin.

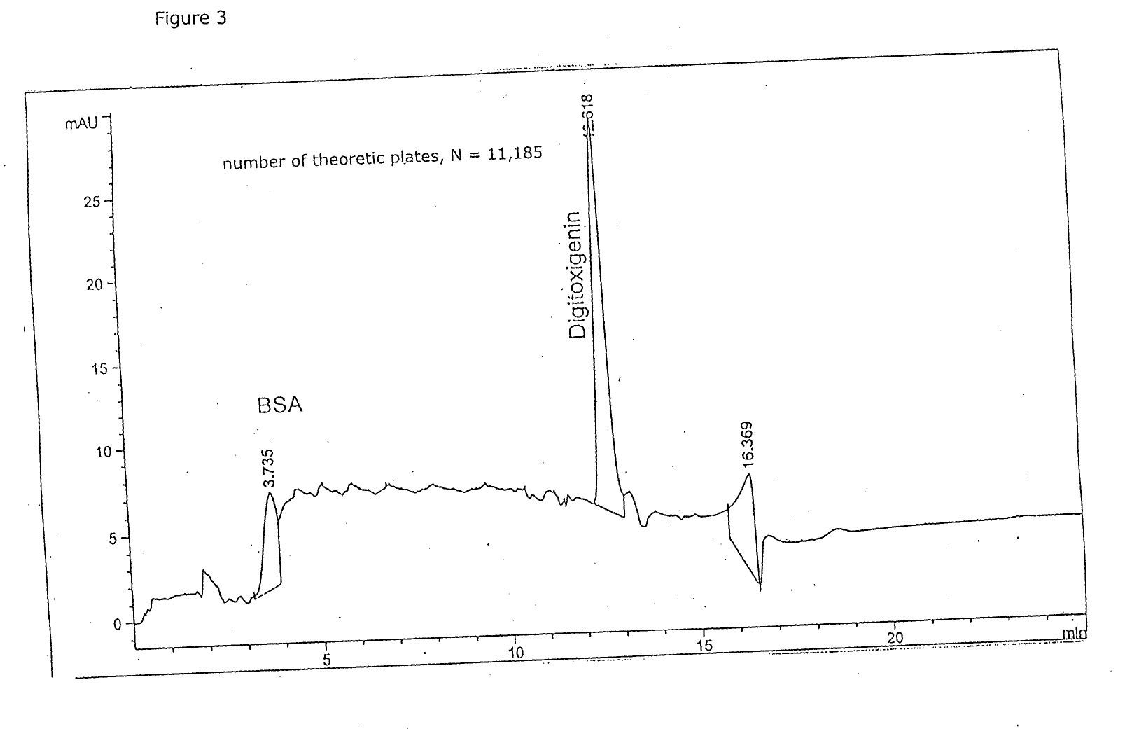

FIG. 3 shows the electropherogram of digitoxigenin.

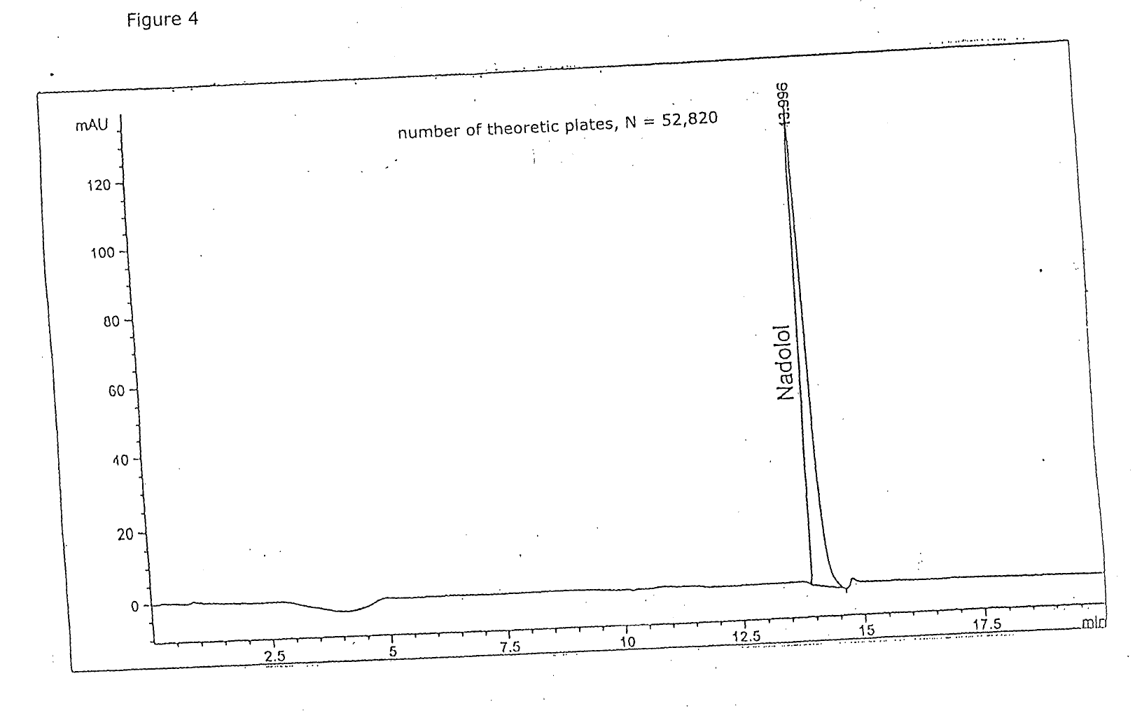

FIG. 4 shows the electropherogram of nadolol.

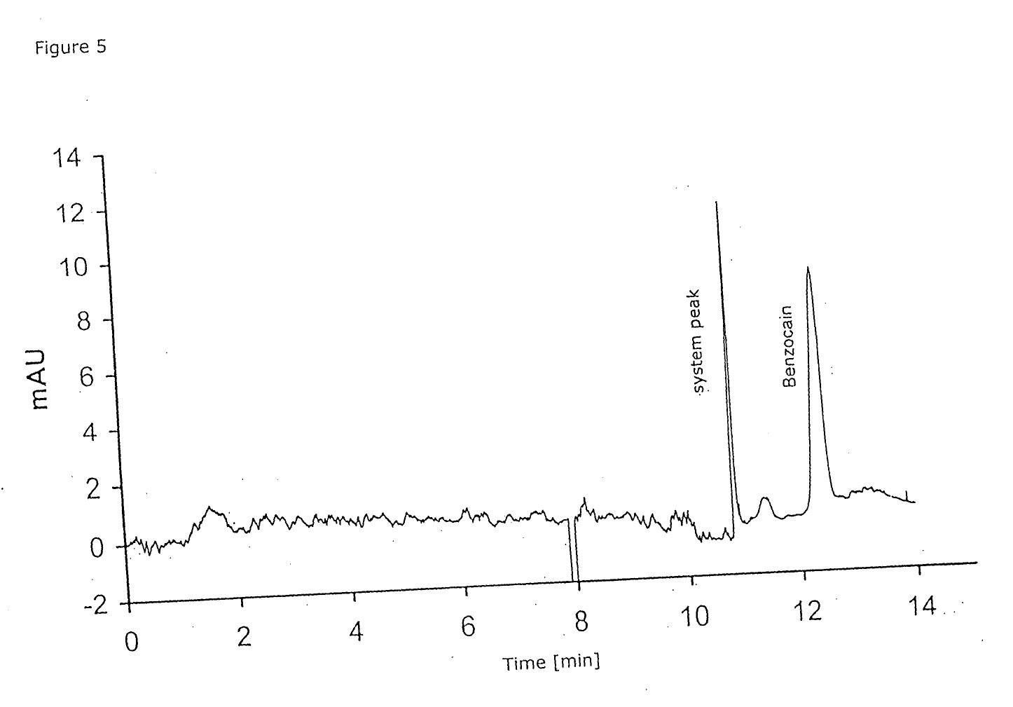

FIG. 5 shows the electropherogram of benzocain.

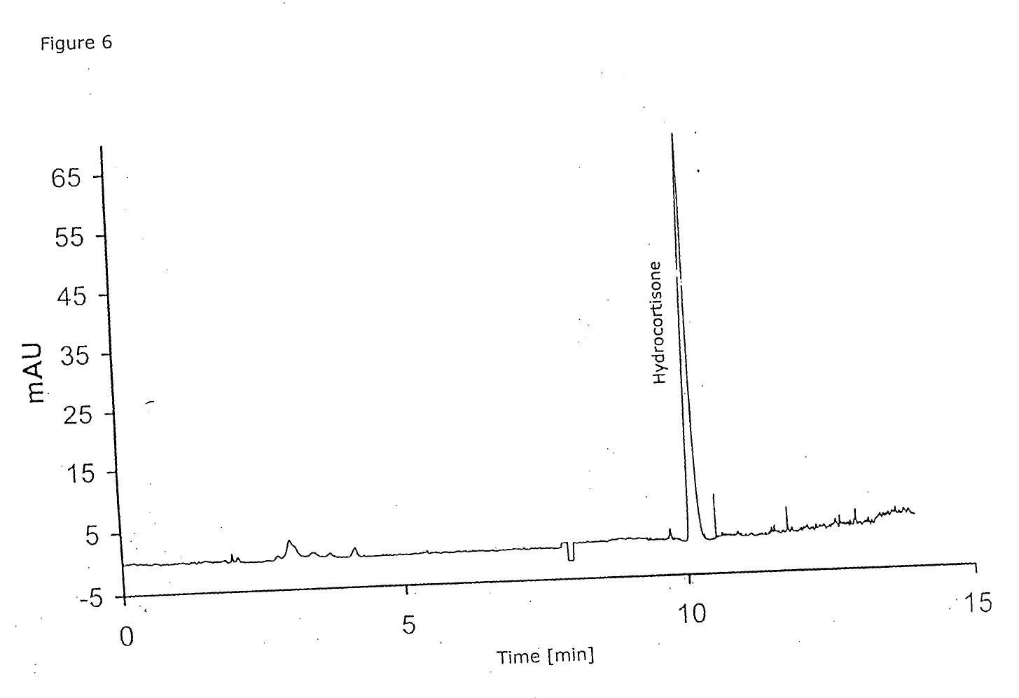

FIG. 6 shows the electropherogram of hydrocortisone.

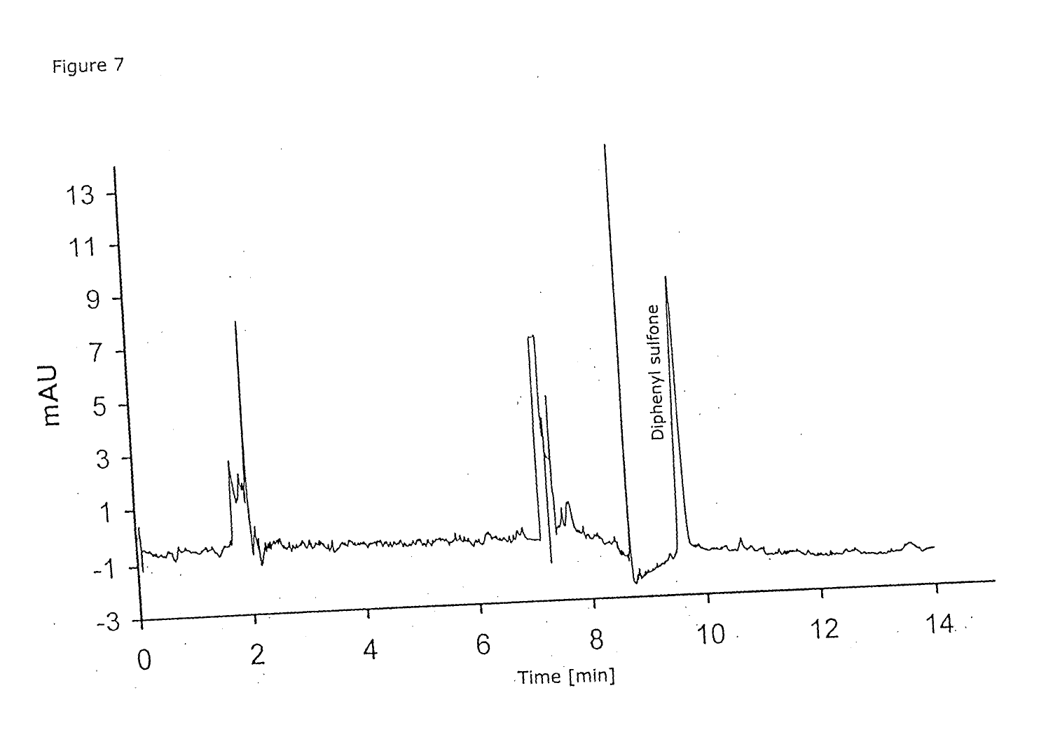

FIG. 7 shows the electropherogram of diphenyl sulfone.

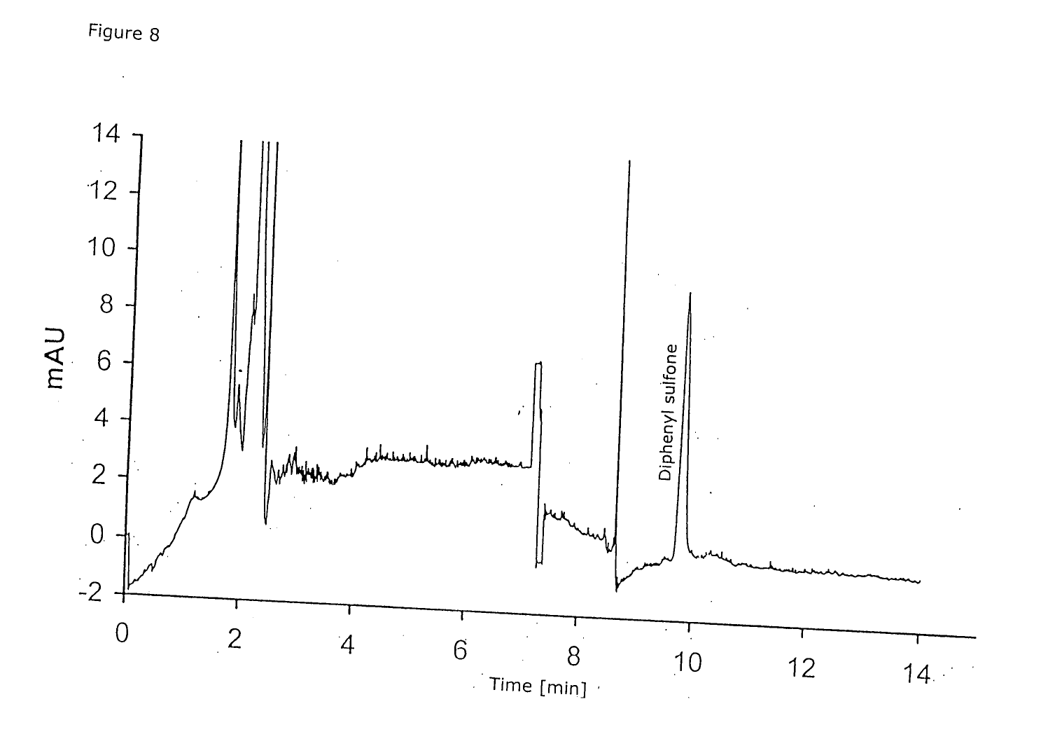

FIG. 8 shows the electropherogram of diphenyl sulfone with concentration of the analyte by a factor of 10.

A particularly advantageous embodiment of the device is represented in FIG. 1. A CEC column (30) packed with the support material (60) according to the invention is immersed with both ends in the container (90) with the mobile phase (120). The voltage source (10) serves for applying a voltage between the two ends of the columns. The voltage enables the build-up of an electro-osmotic flow in the column. In addition, a device for applying pressure to the containers may also be provided. The applying of pressure uniformly to both ends of the column counteracts the degassing of the buffer solutions and thus the formation of air bubbles in the column. One column end is designed for taking up the sample. A changing device enables the changing of the containers (90) and thus the changing or adaptation of the buffer solutions (120) to the process step. By applying, for example, a detector (150) as outlined in FIG. 1 directly on the column, the analyte can be directly detected and analyzed.

In a further embodiment of the device, it is preferred that the column system consist of at least one CEC column for sample processing and at least one CEC column for separation of the analyte which are interconnected through a capillary system, wherein this capillary system, in a particularly preferred embodiment, has at least one outlet through which the sample matrix can be removed. In addition, it is also possible to use a CEC column (30) only for sample processing. It is also possible to transfer the analyte to other analytical or separating systems after separating off the sample matrix.

The device may also provide a coupling of the column system to at least one detector, especially mass spectrometer and/or light-scattering detector or other optical detector and/or electrochemical detector (150).

FIG. 2 shows the electropherogram of digitoxigenin. The performance was effected with a CEC column filled with 5 μm LiChrospher® ADS-C18 particles (pore size 6 nm). Length of the packed capillary: 8.3 cm. Inner diameter: 100 μm. Detection wavelength: 210 nm. For further conditions, see Example 1.

FIG. 3 shows the electropherogram of digitoxigenin separated from BSA (bovine serum albumin) by the use of the support materials according to the invention. The performance was effected with a CEC column filled with 5 μm LiChrospher® ADS-C18 particles (pore size 6 nm). Length of the packed capillary: 8.3 cm. Inner diameter: 100 μm. Detection wavelength: 210 nm. For further conditions, see Example 1.

FIG. 4 shows the electropherogram of nadolol. The performance was effected with a CEC column filled with 5 μm LiChrospher® ADS-C18 particles (pore size 6 nm). Length of the packed capillary: 8.3 cm. Inner diameter: 100 μm. Detection wavelength: 210 nm. For further conditions, see Example 2.

FIG. 5 shows the electropherogram of benzocain. The performance was effected with a CEC column filled with 2 μm LiChrospher® ADS-C18 particles (pore size 6 nm). Length of the packed capillary: 8.3 cm. Inner diameter: 100 μm. Detection wavelength: 210 nm. For further conditions, see Example 3.

FIG. 6 shows the electropherogram of hydrocortisone. The performance was effected with a CEC column filled with 2 μm LiChrospher® ADS-C18 particles (pore size 6 nm). Length of the packed capillary: 8.3 cm. Inner diameter: 100 μm. Detection wavelength: 240 nm. For further conditions, see Example 1.

FIG. 7 shows the electropherogram of diphenyl sulfone as a control for the concentration experiment in FIG. 8. The performance was effected with a CEC column filled with 2 μm LiChrospher® ADS-C18 particles (pore size 6 nm). Length of the packed capillary: 8.3 cm. Inner diameter: 100 μm. Detection wavelength: 210 nm. For further conditions, see Example 5.

FIG. 8 shows the electropherogram of diphenyl sulfone with concentration of the analyte by a factor of 10. The performance was effected with a CEC column filled with 2 μm LiChrospher® ADS-C18 particles (pore size 6 nm). Length of the packed capillary: 8.3 cm. Inner diameter: 100 μm. Detection wavelength: 210 nm. For further conditions, see Example 6.

Even without any further explanations, it is considered that a skilled person will be able to make use of the above description to the greatest extent. Therefore, the preferred embodiment and Examples are to be considered a merely descriptive disclosure which is by no means limiting in any way.

The complete disclosures of all applications, patents and publications stated hereinbefore and hereinafter are incorporated herein by reference. Also, the disclosure of the corresponding application DE 199 07 296.5, filed on Feb. 22, 1999, as far as relating to support materials which are based on a base material containing hydroxy groups and have reversed phases limited to the inner surfaces of porous particles, said reversed phases consisting of fatty acid residues, is incorporated herein by reference.

### EXAMPLE 1

Separation of Digitoxigenin in the Presence and Absence of BSA

Materials Employed:

The CEC column having a length of 8.3 cm and an inner diameter of 100 μm was packed with LiChrospher® ADS-C18 supplied by Merck of Darmstadt. The particles employed had a diameter of 5 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate.

The elution buffer consisted of 60% acetonitrile, 40% water, 5 mM ammonium acetate.

The control solution contained digitoxigenin (Sigma, Deisenhofen) in a concentration of 0.3 mg/ml in H₂O.

The sample solution contained 1 mg/ml digitoxigenin and 4 mg/ml BSA (bovine serum albumin, Sigma Deisenhofen) in H₂O.

Device

For performing the separation of digitoxigenin, the device shown in FIG. 1 was employed. The column packed with LiChrospher® ADS-C18 was immersed with its ends each in a container for receiving buffer solution. Using a voltage source (10), a voltage was applied between the two ends of the column.

Column Preparation

The column preparation was performed at 15° C. in 2 steps:
1. The CEC column was first equilibrated with washing buffer for 40 min. During this process, a voltage of −5 kV was applied, and in order to prevent the formation of air bubbles, a pressure of 10 bar was applied to both containers. The stability of the column was monitored in the meantime by measuring the current and the UV absorption (at 210 nm).
2. The 2nd equilibration phase took 15 min, a voltage of −15 kV and a pressure of 10 bar being applied. The current and the UV absorption were also monitored.

After the end of the 2nd phase, the current and UV adsorption were stable.

Separations

During the whole operation, the temperature of the buffers, the samples and the separating capillaries was controlled to 15° C.

Digitoxigenin

The sample (digitoxigenin, 0.3 mg/ml in H₂O) was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column. After 9.5 minutes, the washing buffer was replaced by an elution buffer. The conditions of −15 kV and 10 bar were retained. Digitoxigenin was eluted after 12.7 min. The electropherogram of this separation is shown in FIG. 2.

Digitoxigenin in the Presence of BSA

The sample (1 mg/ml digitoxigenin and 4 mg/ml BSA, each in H₂O) was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column, and the BSA was thus removed. After 10 minutes, the washing buffer was replaced by an elution buffer. The conditions of −15 kV and 10 bar were retained. Digitoxigenin was eluted after 12.6 min. The electropherogram of this separation is shown in FIG. 3.

### EXAMPLE 2

Separation of Nadolol

Materials Employed:

The CEC column having a length of 8.3 cm and an inner diameter of 100 μm was packed with LiChrospher® ADS-C18 supplied by Merck of Darmstadt. The particles employed had a diameter of 5 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate.

The elution buffer consisted of 60% acetonitrile, 40% water, 10 mM ammonium acetate.

The solution contained nadolol (Sigma, Deisenhofen) in a concentration of 0.3 mg/ml in H₂O.

Device

The device was the same as that used in Example 1.

Column Preparation

The column preparation was performed in accordance with Example 1.

Separation

During the whole operation, the temperature of the buffers, the samples and the separating capillaries was controlled to 15° C.

Nadolol (1 mg/ml) was electrokinetically charged by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column, and the BSA was thus removed. After 10 minutes, the washing buffer was replaced by an elution buffer. The conditions of −15 kV and 10 bar were retained. Nadolol was eluted after 13.99 min. The electropherogram of this separation is shown in FIG. 4.

### EXAMPLE 3

Separation of Benzocain in Human Plasma

Materials Employed:

The CEC column having a length of 8.3 cm and an inner diameter of 100 μm was packed with LiChrospher® ADS-C18 particles. The particles employed had a diameter of 2 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate, pH 4.7. The elution buffer consisted of 60% acetonitrile, 40% water, 5 mM ammonium acetate, pH 4.7.

The sample solution consisted of human plasma doped with 0.5 mg/ml benzocain.

Device

The device was the same as that used in Example 1.

Column Preparation

The column preparation was performed at 15° C. in 2 steps:
1. The column was first equilibrated with separation buffer. During this process, a stepwise rise of the voltage in 5 kV steps from −5 kV to −20 kV was performed at an interval of 5 min each. During this, a pressure of 5 bar was applied to the inlet buffer container. Then, a pressure of 10 bar was applied to both containers, and a voltage of −15 kV was applied. The stability of the column was monitored in the meantime by measuring the current and the UV absorption (at 210 nm).
2. The 2nd equilibration phase was effected in washing buffer and took 12 min, a voltage of −15 kV and a pressure of 10 bar to both buffer containers being applied. The current and the voltage were also monitored.

After the end of the 2nd phase, the current and UV adsorption were stable.

Separation

During the whole operation, the temperature of the buffers, the samples and the separating capillaries was controlled to 15° C.

The sample was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column. This removed the proteins and salts from the model matrix. After 7.7 minutes, the washing buffer was replaced by an elution buffer. The conditions of −15 kV and 10 bar were retained. The benzocain was eluted at 12.37 min. The electropherogram is shown in FIG. 5.

### EXAMPLE 4

Separation of Hydrocortisone in Human Serum

Materials Employed:

The CEC column having a length of 8.3 cm and an inner diameter of 100 μm was packed with LiChrospher® ADS-C18 particles. The particles employed had a diameter of 2 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate, pH 4.7. The elution buffer consisted of 60% acetonitrile, 40% water, 5 mM ammonium acetate, pH 4.7.

The sample solution consisted of human serum doped with 0.5 mg/ml hydrocortisone.

Device

The device was the same as that used in Example 1.

Column Preparation

The column preparation was performed in accordance with Example 3.

Separation

The separation was performed as described in Example 3.

The hydrocortisone was eluted at 10.10 min. The electropherogram is shown in FIG. 6.

### EXAMPLE 5

Separation of Diphenyl Sulfone in a Serum-Containing Salt Solution

Materials Employed:

The CEC column having a length of 8.3 cm and an inner diameter of 100 μm was packed with LiChrospher® ADS-C18 particles. The particles employed had a diameter of 2 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate, pH 4.7. The elution buffer consisted of 60% acetonitrile, 40% water, 5 mM ammonium acetate, pH 4.7.

The sample solution consisted of 0.1 mg/ml diphenyl sulfone in 250 μl/ml of fetal calf serum in Hank's Balanced Salt Solution.

Device

The device was the same as that used in Example 1.

Column Preparation

The column preparation was performed in accordance with Example 3.

Separations

During the whole operation, the temperature of the buffers, the samples and the separating capillaries was controlled to 15° C.

The sample was electrokinetically charged onto the column by applying a voltage of −5 kV for 3 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column. This removed the proteins and salts from the model matrix. After 7.7 minutes, the washing buffer was replaced by an elution buffer. The conditions of −15 kV and 10 bar were retained. The diphenyl sulfone was eluted at 9.610 min and had a peak area of 85.5 mAU.s. The electropherogram of this separation is shown in FIG. 7.

### EXAMPLE 6

Tenfold Concentration and Subsequent Separation of Diphenyl Sulfone in a Serum-Containing Salt Solution

Materials Employed:

The CEC column having a length of 8.3 cm and an inner diameter of 100 μm was packed with LiChrospher® ADS-C18 particles. The particles employed had a diameter of 2 μm and a pore size of 6 nm.

The determination of grain size was effected with a Malvern Mastersizer. The measurement of the pore diameter was performed with Micometrics ASAP 2400 equipment. The pore diameter was obtained by determining the desorption or adsorption.

The washing buffer consisted of 5% acetonitrile, 95% water, 5 mM ammonium acetate, pH 4.7. The elution buffer consisted of 60% acetonitrile, 40% water, 5 mM ammonium acetate, pH 4.7.

The sample solution consisted of 0.01 mg/ml diphenyl sulfone in 250 μl/ml of fetal calf serum in Hank's Balanced Salt Solution.

Device

The device was the same as that used in Example 1.

Column Preparation

The column preparation was performed in accordance with Example 3.

Separations

During the whole operation, the temperature of the buffers, the samples and the separating capillaries was controlled to 15° C.

The sample was electrokinetically concentrated on the column by applying a voltage of −5 kV for 30 seconds. Subsequently, a small amount of washing buffer, a so-called buffer plug, was charged onto the column under the same conditions in order to prevent the possible diffusion of the sample into the buffer container.

Subsequently, the sample was washed by applying the washing buffer at a voltage of −15 kV and applying a pressure of 10 bar to both ends of the column. This removed the proteins and salts from the model matrix. After 7.7 minutes, the washing buffer was replaced by an elution buffer. The conditions of −15 kV and 10 bar were retained. The diphenyl sulfone was eluted at 9.805 min and had a peak area of 84 mAU.s. The electropherogram of this separation is shown in FIG. 8.

1-2. (canceled)

3. A capillary electrochromatography system comprising
a capillary for electrochromatography filled with
a support material, the support material being based on a porous particulate base material containing hydroxy groups and porous particles having inner surfaces, wherein the porous particulate base material has reversed phases limited to the inner surfaces of the porous particles, the reversed phases consisting of fatty acid residues. A capillary for capillary electrochromatography filled with support material characterized in that the support material in the capillary, which is based on a base material containing hydroxy groups, has reversed phases which are limited to the inner surfaces of porous particles, said reversed phases consisting of fatty acid residues.

4. Use of a capillary filled with a support material for capillary electrochromatography (CEC) comprising
applying a biological sample to the capillary in a CEC column, the biological sample comprising an analyte in a matrix,
applying a voltage across the CEC column to produce an electro-osmotic flow, whereby molecules in the sample migrate according to the charge-to-mass ratio of the molecules,
applying a wash buffer to elute the sample matrix from the column, and
applying a transfer buffer to elute the analyte from the column, thereby, separating the analyte from the biological sample matrix, characterized in that the capillary is filled with a support material based on a porous particulate base material containing hydroxy groups and porous particles having inner surfaces, wherein the porous particulate base material has reversed phases limited to the inner surfaces of the porous particles, the reversed phases consisting of fatty acid residues.

5. A capillary electrochromatography (CEC) method comprising comprising applying a biological sample to a capillary in a CEC column, wherein the capillary is filled with a support material based on a porous particulate base material containing hydroxy groups and porous particles having inner surfaces, wherein the porous particulate base material has reversed phases limited to the inner surfaces of the porous particles, said reversed phases consisting of fatty acid residues wherein the biological sample comprises an analyte in a matrix comprising
applying a voltage across the CEC column to produce an electro-osmotic flow, whereby molecules in the sample migrate according to the charge-to-mass ratio of the molecules comprising
applying a wash buffer to elute the sample matrix from the column; comprising
applying a transfer buffer to elute the analyte from the column; thereby, separating the analyte from the biological sample matrix.
